(19) United States
(12) Patent Application Publication
(10) Pub. No.: US 2015/0136258 A1
(43) Pub. Date: May 21, 2015

(54) SPOOL ASSEMBLY AND A VALVE COMPRISING THE SAME

(71) Applicant: GUANGZHOU SEAGULL KITCHEN AND BATH PRODUCTS CO., LTD., Guangdong (CN)

(72) Inventors: Xunping Yuan, Guangdong (CN); Zhiqiang Tang, Guangdong (CN)

(73) Assignee: GUANGZHOU SEAGULL KITCHEN AND BATH PRODUCTS CO., LTD., Guangdong (CN)

(21) Appl. No.: 14/118,672

(22) PCT Filed: Jun. 28, 2012
(86) PCT No.: PCT/CN2012/077775

§ 371 Date: Nov. 19, 2013

(30) Foreign Application Priority Data
Dec. 26, 2011 (CN) 201110443605.4

(51) Int. Cl. F16K 11/07; F16K 27/04; F16K 15/18

(52) U.S. Cl. CPC F16K 11/07; F16K 15/18; F16K 27/04
USPC 137/625.31; 137/599.08

(57) ABSTRACT

A spool assembly includes an mounting base, having a upper mounting section and a lower mounting section arranged in axial direction; a first outlet, disposed between the upper mounting section and the lower mounting section; a stationary member, mounted on the lower mounting section, and having a stationary member diversion area; a movable member, one end face of which may be attached to one end face of the stationary member, and having a movable member diversion area located on the same plane with said first outlet; a mandrel, mounted on said upper mounting section and having a blocked upper end and a cavity; the lower end of said mandrel and said movable member have a diversion area located therebetween, which may be in communication with said cavity; the stationary member diversion area communicated or staggered with the mobile diversion area when the mandrel drives the movable member to rotate.

### FIELD OF THE INVENTION

The present relates to a device for transmitting and controlling liquid, in particular, a spool assembly applied in a valve and a valve comprising the same.

### DESCRIPTION OF RELATED ART

A spool assembly is an important member of a valve, which is generally disposed in the cavity of the valve body of a valve and adapted for controlling fluid flowing through the valve.

Referring to FIG. 1, it shows an existing spool assembly that comprises an mounting base with an upper mounting section 11 and a lower mounting section 12, and a first outlet 13 arranged between said upper mounting section 11 and said lower mounting section 12; a stationary member 2 with a stationary member diversion area, mounted on said lower mounting section 12; a movable member 3 with a movable member diversion area, one end of which is attached to one end of said stationary member (2), wherein the movable member diversion area is arranged coaxial with the first outlet 13, which means the movable member diversion area is in communication with the first outlet 13; a solid spool, mounted on the upper mounting section 11, a lower end of which is attached to the movable member 3 and fixed thereto, and when the spool 4 drives the movable member 3 to make a radial rotation, the movable member diversion area may be communicated or staggered with the stationary member diversion area, and when the movable member diversion area is in communication with the stationary member diversion area, fluid may flow out of the side wall of the movable member 3 (i.e. flow out from the first outlet 13). Generally, the spool assembly is mounted in the cavity of the valve body of the valve, and a gap A (shown in FIG. 2) between the outlet of the spool assembly and the inner wall of the valve body may be related to water discharge under certain pressure. If it is expected to obtain larger water discharge under the same pressure, the gap A needs to be enlarged. However, if the gap A is enlarged through reducing the diameter of the entire spool, the section surface of the movable member diversion area and the stationary member diversion area may be reduced, so as to cause negative impact on water discharge of the valve. For the abovementioned spool assembly, generally, larger water discharge is obtained by enlarging the diameter of the valve body, which may cause a larger diameter of the valve body of the valve and also higher cost.

### SUMMARY OF THE INVENTION

In view of the above-described problems, one of the objectives of this invention is to provide a spool assembly that may discharge a large amount of water with lower cost.

Another objective of this invention is to provide a valve using the same.

To achieve the above mentioned objectives, in accordance with one embodiment of this invention, there is provided a spool assembly, comprising a mounting base having a upper mounting section and a lower mounting section arranged in axial direction; a first outlet disposed between the upper mounting section and the lower mounting section; a mandrel having a rotating shaft and mounted on the upper mounting section; a movable member mounted at a lower end of the mandrel and having a movable member diversion area located on the same plane with the first outlet, and the plane may be perpendicular to the rotating shaft; a stationary member mounted on the lower mounting section, one end face of which may be attached to one end face of the movable member, and having a stationary member diversion area communicated or staggered with the movable member diversion area when the mandrel drives the movable member to rotate. The mandrel has a blocked upper end and a cavity, and at least a second outlet may be disposed on an external wall of the mandrel; the lower end of the mandrel and the movable member have a diversion area located therebetween, which may be in communication with the cavity.

In a class of this embodiment, at least one first axial convex member may be disposed at the lower end of the mandrel, and an axial recess may be disposed at an upper end of the movable member; the height of the first convex member may be larger than the depth of the axial recess; after one part of the first axial convex member is inserted into the recess and fixed therein, the diversion area is formed between the other part of the first axial convex member and the movable member and at the lower end of the mandrel.

In a class of this embodiment, a first axial convex member and a second axial convex member may be disposed at the lower end of the mandrel, and the height of the first axial convex member may be larger than that of the second axial convex member, and a recess may be disposed on an upper end face of the movable member; after the first axial convex member is inserted into the recess and fixed therein, the diversion area is formed between the second axial convex member and the movable member and at the lower end of the mandrel.

In a class of this embodiment, the lower mounting section of the mounting base comprises an internal wall having a pair of recesses disposed thereon and towards each other, and the stationary member comprises an external wall having a pair of convex parts disposed thereon and towards each other, and the convex part may be respectively inserted into the corresponding recesses.

In a class of this embodiment, the movable member diversion area may consist of a pair of sectorial gaps symmetrically arranged along the external wall of the movable member and towards each other, and the stationary member diversion area may consist of a pair of sectorial grooves symmetrically disposed on the stationary member.

In a class of this embodiment, the movable member diversion area may be a sectorial gap arranged along the external wall of the movable member, and the stationary member diversion area may be sectorial groove disposed on the stationary member.

In accordance with another embodiment of this invention, there is provided a valve comprising a spool assembly of any one of the above mentioned aspects.

In accordance with another embodiment of this invention, the valve further comprises a tubular valve body having an inlet and an outlet; and a valve stem disposed inside the valve body, one end of which may be secured to a mandrel of the spool assembly in a demountable manner, and the other end of which may be secured to a rotating controller close to the outlet in a demountable manner; the spool assembly is disposed close to and coaxial with the inlet.

In accordance with another embodiment of this invention, the valve body has a pneumatic water discharging device mounted on a side wall thereof, which is adapted for preventing liquid in the valve body from flowing out of the pneumatic water discharging device when the valve is opened, and for draining remaining liquid out of the valve body from the outlet when the valve is closed.

In accordance with another embodiment of this invention, the valve further comprises a check valve, disposed at the inlet and adapted for closing up automatically when pressure on the check valve from inside of the valve body is larger than that from inlet side.

In accordance with another embodiment of this invention, the valve further comprises a V-shaped ring holding around one end of the valve stem connected with the mandrel, which is also firmly attached to an internal wall of the valve body when liquid pressure at the outlet is larger than that at the inlet.

Advantages of the spool assembly of this invention are summarized below:

1. It is advantageous for the spool assembly of this invention, to comprise a mounting base having a upper mounting section and a lower mounting section arranged in axial direction; a first outlet disposed between the upper mounting section and the lower mounting section; a mandrel having a rotating shaft and mounted on the upper mounting section; a movable member mounted at a lower end of the mandrel and having a movable member diversion area located on the same plane with the first outlet; a stationary member mounted on the lower mounting section, one end face of which may be attached to one end face of the movable member, and having a stationary member diversion area communicated or staggered with the movable member diversion area when the mandrel drives the movable member to rotate; wherein the plane may be perpendicular to the rotating shaft, and the mandrel has a blocked upper end and a cavity, and at least a second outlet may be disposed on an external wall of the mandrel; the lower end of the mandrel and the movable member have a diversion area located therebetween, which may be in communication with the cavity. It is because that one part of liquid flows into the cavity of the mandrel through the diversion area, and then flows into the valve body through the second outlet, and based on this structure, comparing with the existing technology, even the gap A is decreased, one part of liquid flows out of the diversion area of the movable member diversion area and finally flows into the valve body through the first outlet, meanwhile, the other part of fluid flows into the mandrel through the diversion area and finally flows into the valve body through the second outlet. Thus, larger amount of water discharge may be achieved under a certain pressure together with a decreased diameter of the valve body, so as to reduce the cost.

2. It is advantageous for the spool assembly of this invention to comprise a diversion area designed in several ways. It is preferred that at least one first axial convex member may be disposed at the lower end of the mandrel, and an axial recess may be disposed at an upper end of the movable member; the height of the first axial convex member may be larger than the depth of the axial recess; after one part of the first axial convex member is inserted into the axial recess and fixed therein, the diversion area is formed between the other part of the first axial convex member and the movable member and at the lower end of the mandrel, which may achieve a simple structure. However, the diversion area may be designed in another preferred way that a first axial convex member and a second axial convex member may be disposed at the lower end of the mandrel, and the height of the first axial convex member may be larger than that of the second axial convex member, and a recess may be disposed on an upper end face of the movable member; after the first axial convex member is inserted into the recess and fixed therein, the diversion area is formed between the second axial convex member and the movable member and at the lower end of the mandrel. Because the height of the first axial convex member is larger than that of the second axial convex member, and the diversion area is formed between the second axial convex member and the movable member and at the lower end of the mandrel after the first axial convex member is inserted into the recess and fixed therein, this structure may ensure a greater strength as well as better fixing effect.

3. It is advantageous for the spool assembly of this invention to comprise a stationary member mounted on the mounting base, so that when the mandrel makes radial rotation, the movable member may be forced to rotate relative to the stationary member, so as to open or close the spool. The stationary member may be mounted on the mounting base in several ways. It is preferred that the lower mounting section of the mounting base comprises an internal wall having a pair of recesses disposed thereon and towards each other, and the stationary member comprises an external wall having a pair of convex parts disposed thereon and towards each other, and the convex part may be respectively inserted into the corresponding recesses. Such fixation may achieve simplicity of structure as well as ease of being manufactured. In addition, when the mandrel rotates axially, the smaller impact on fixation of the stationary member and the mounting base may be caused. Furthermore, it is preferred that the lower mounting section of the mounting base comprises a female screw arranged thereon and in axial direction, and the stationary member comprises an external wall having a male screw arranged thereon and in axial direction, which matches with the female screw. The stationary member is mounted on the lower mounting section through cooperation between the female screw and the male screw. As screw fixation may achieve standardization of mounting, it will be easier for replacement of the member.

4. It is advantageous for the spool assembly of this invention, preferably, to comprise a movable member diversion area that consist of a pair of sectorial gaps symmetrically arranged along the external wall of the movable member, and a stationary member diversion area that consist of a pair of sectorial grooves symmetrically disposed on the stationary member, so that the spool assembly may be controlled in a manner of rotating 0-90 degree, so as to save human labor. In addition, the movable member diversion area may be a sectorial gap arranged along the external wall of the movable member, and the stationary member diversion area may be a sectorial groove disposed on the stationary member, so that the spool assembly may be opened by rotating 180 degree, which is convenient for meticulous control.

Advantages of the valve comprising any one of the above mentioned spool assemblies of this invention are summarized below:

1. As comprising the above mentioned spool assembly, the valve may have all advantages of the spool assembly mentioned above.

2. It is preferred that the valve comprises a tubular valve body having an inlet and an outlet; and a valve stem disposed inside the valve body, one end of which is secured to the mandrel in a demountable manner, and the other end of which is secured to a rotating controller close to the outlet in a demountable manner. The rotating controller is disposed close to the outlet while the spool assembly is disposed close to and coaxial with the inlet. Liquid flows into the valve body through the inlet and the rotating controller drives the valve stem to rotate inside the valve body so as to drive the mandrel further with the movable member to rotate relative to the stationary member, so that the movable member diversion area can communicate with the stationary member diversion area, and then liquid flows into the spool assembly with one part towards the outlet through the first outlet and the other part towards the cavity of the mandrel along the diversion area, and eventually flows towards the outlet through the second outlet. Thus, larger amount of water discharge can be achieved under the same pressure. Additionally, it is possible to decrease the diameter of the valve body accordingly, since the liquid can flow inside the mandrel, which may save the cost.

3. The valve of this invention, the valve body has a pneumatic water discharging device mounted on the side wall thereof, which is adapted for preventing liquid in the valve body from flowing out of the pneumatic water discharging device when the valve is opened, and for discharging remaining liquid out of the valve body through the outlet when the valve is closed. Thus, when the valve stops working, the liquid remaining inside the valve body can be discharged through the pneumatic water discharging device which is adapted for outdoor use, especially for antifreezing faucet.

4. It is preferred that the valve of this invention further comprises a check valve, disposed at the inlet and adapted for closing up automatically when pressure on the check valve from inside of the valve body is larger than that from inlet side, so as to prevent liquid inside the valve body from flowing back.

5. It is preferred that the valve further comprises a V-shaped ring holding around one end of the valve stem connected with the mandrel, which is also firmly attached to an internal wall of the valve body when liquid pressure at the outlet is larger than that at the inlet. The outlet is often connected to a soft tube in practice, so when the soft tube is lifted up, the pressure at the outlet is usually larger than that at the inlet, which may cause liquid to flow back. Since the V-shaped ring of the valve of this invention is firmly attached to the internal wall of the valve body when liquid pressure at the outlet is larger than that at the inlet, flowing back liquid may be avoid when the soft tube is lifted up.

### BRIEF DESCRIPTION OF THE DRAWINGS

Detailed description will be given below in conjunction with accompanying drawings:

FIG. 1 is a structural diagram of a spool assembly of prior art;

FIG. 2 is a structural diagram of a valve comprising the spool assembly of FIG. 1 of prior art;

FIG. 3 is a structural diagram of a spool assembly of one embodiment of this invention that can be controlled in a manner of rotating 0-90 degree;

FIG. 4 is a structural diagram of a movable member of one embodiment of this invention that can be rotating controlled in a manner of rotating 0-90 degree;

FIG. 5 is a structural diagram of a stationary member of one embodiment of this invention that can be controlled in a manner of rotating 0-90 degree;

FIG. 6 is a structural diagram of a mandrel of one embodiment of this invention;

FIG. 7 is a sectional view of the stationary member and the movable member when the spool assembly of FIG. 3 is at its closing state;

FIG. 8 is a sectional view of the stationary member and the movable member when the spool assembly of FIG. 3 is at its opening state;

FIG. 9 is a structural diagram of the spool assembly of FIG. 3 when it is at its closing state;

FIG. 10 is a structural diagram of the spool assembly of FIG. 3 when it is at its opening state;

FIG. 11 is a structural diagram of a valve comprising the spool assembly of FIG. 3;

FIG. 12 is a structural diagram of a stationary member of one embodiment of this invention that can be controlled in a manner of rotating 0-180 degree;

FIG. 13 is a structural diagram of a movable member of one embodiment of this invention that can be controlled in a manner of rotating 0-180 degree;

FIG. 14 is a structural diagram of the spool assembly of one embodiment of this invention that can be controlled in a manner of rotating 0-180 degree when it is at its opening state;

FIG. 15 is a structural diagram of the spool assembly of one embodiment of this invention that can be controlled in a manner of rotating 0-180 degree when it is at its closing state;

FIG. 16 is a structural diagram of a spool assembly of one embodiment of this invention that can be controlled in a manner of rotating 0-180 degree;

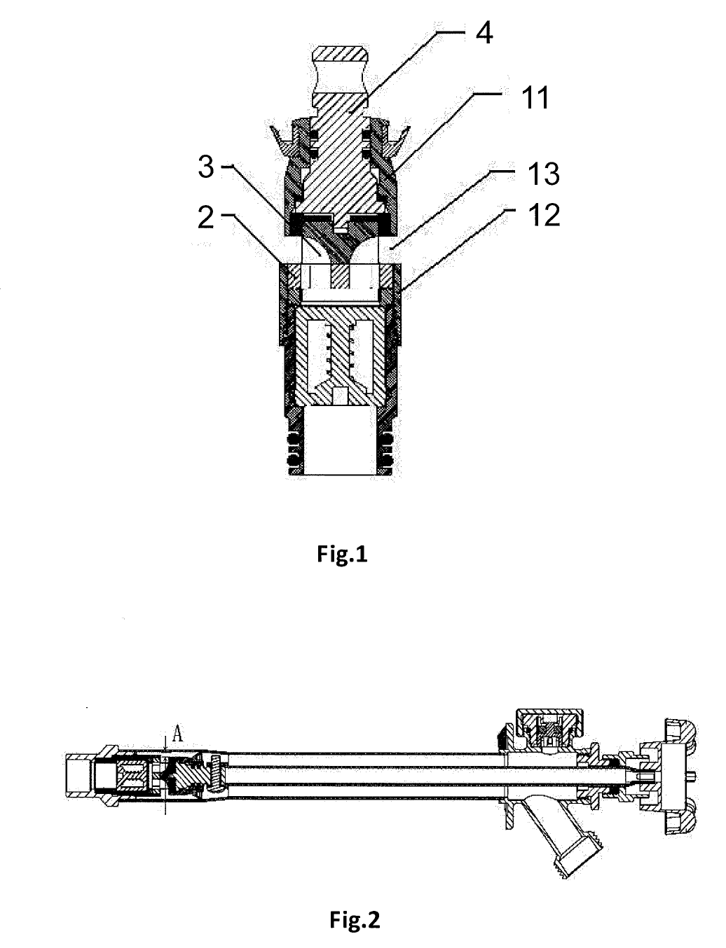

In the drawings, the following reference numbers are used:

1—mounting base; 11—upper mounting section; 12—lower mounting section; 13—first outlet; 2—stationary member; 21—stationary member diversion area; 22—convex part; 3—movable member; 31—movable member diversion area; 32—axial recess; 4—mandrel; 41—cavity; 42—second outlet; 43—first axial convex member; 44—second axial convex member; 45—clasp ring; 46—O-shaped ring; 47—drag ring; 5—diversion area; 6—valve body; 7—inlet; 8—outlet; 9—valve stem; 10—rotating controller; 14—pneumatic water discharging device; 15—check valve; 16—first bolt; 17—joint; 18—snap ring; 19—sleeve; 20—second bolt.

### DETAILED DESCRIPTION OF THE EMBODIMENTS

One of the objectives of this invention is to provide a spool assembly, being able to discharge larger amount of water with a decreased diameter of the valve body and low cost. Another objective of this invention is to provide a valve comprising the above mentioned spool assembly.

One preferred embodiment of this invention in combination with the figures are provided as bellow.

### Embodiment 1

### Spool Assembly

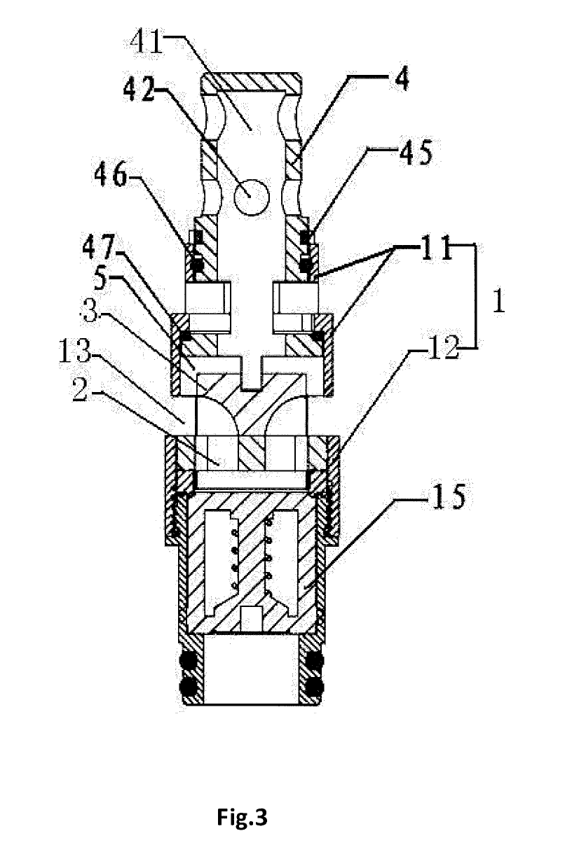

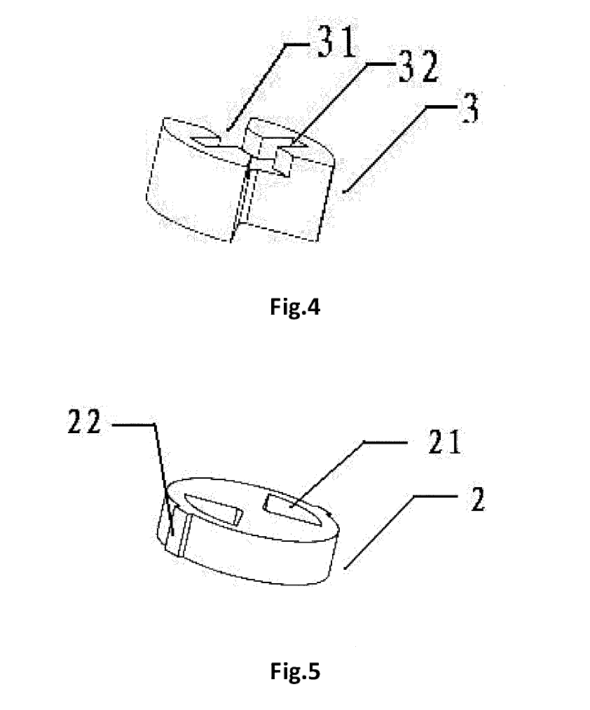

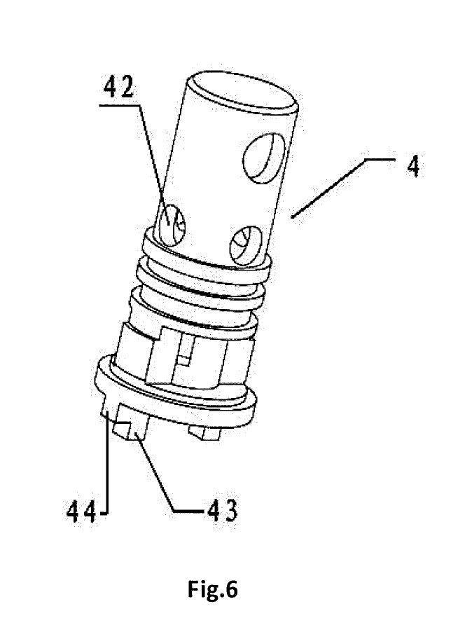

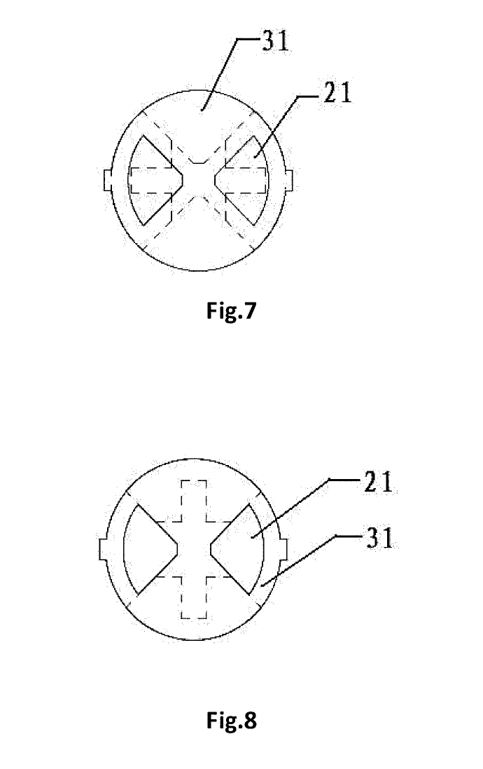

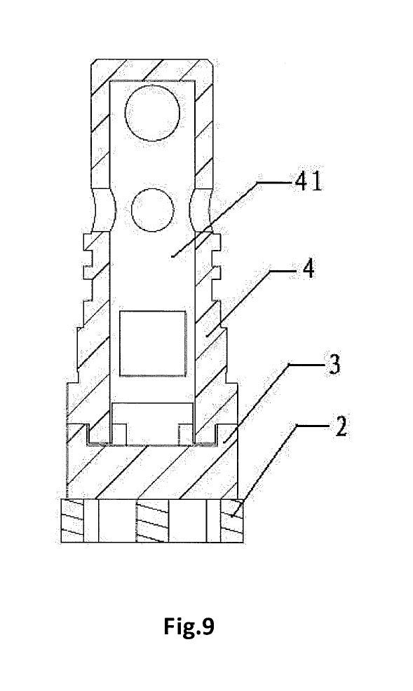

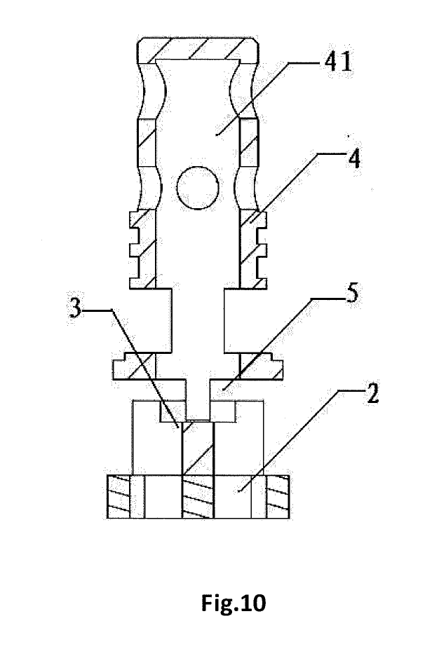

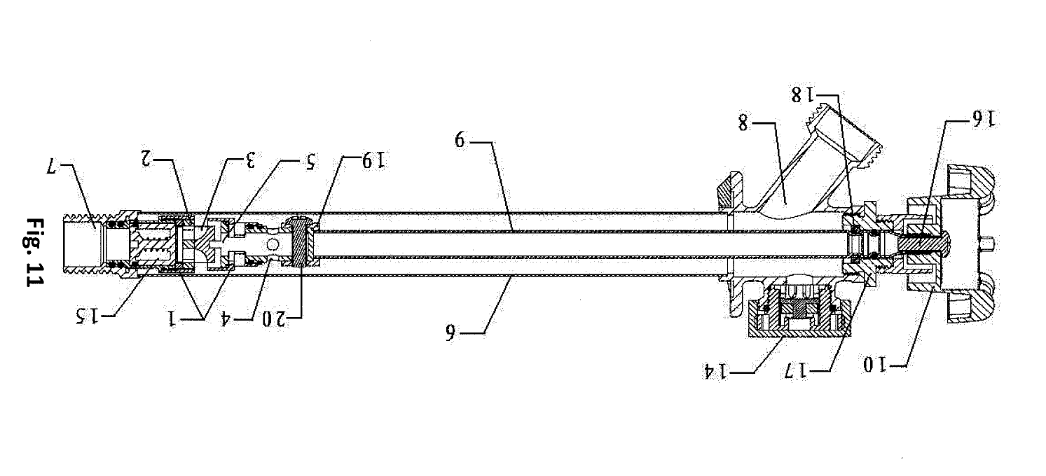

Refer to FIG. 3, a spool assembly of this embodiment, comprises a mounting base 1 having a upper mounting section 11 and a lower mounting section 12 arranged in axial direction; a first outlet 13 disposed between the upper mounting section 11 and the lower mounting section 12; a mandrel 4 (shown in FIG. 6), having a rotating shaft and mounted on the upper mounting section 11; a movable member 3 (shown in FIG. 4), mounted at a lower end of the mandrel 4 and having a movable member diversion area 31 located on the same plane with the first outlet 13; a stationary member 2 (shown in FIG. 5), mounted on the lower mounting section 12, one end face of which is attached to one end face of the movable member 3, and having a stationary member diversion area 21 communicated (shown in FIG. 8 and FIG. 10) or staggered (shown in FIG. 7 and FIG. 9) with the movable member diversion area 31 when the mandrel drives the movable member 3 to rotate; wherein, the plane is perpendicular to the rotating shaft, and the mandrel 4 has a blocked upper end and a cavity 41, and at least a second outlet 42 is disposed on an external wall of the mandrel 4; the lower end of the mandrel 4 and the movable member 3 have a diversion area 5 located therebetween, which is in communication with the cavity 41.

Refer to FIG. 3, the diversion area 5 of the spool assembly of this embodiment may be designed in several ways. In this embodiment, a first axial convex member 43 and a second axial convex member 44 are disposed at the lower end of the mandrel 4, and the height of the first axial convex member 43 is larger than that of the second axial convex member 44, and a recess 32 is disposed on an upper end face of the movable member (shown in FIG. 4); after the first axial convex member 43 is inserted into the recess 32 and fixed therein, the diversion area 5 is formed between the second axial convex member 44 and the movable member 3 and at the lower end of the mandrel 4.

Alternatively, the diversion area 5 may be designed in some other ways. For example, a first axial convex member 43 is disposed at the lower end of the mandrel 4, and an axial recess 32 is disposed at an upper end of the movable member 3; the height of the first axial convex member 43 is larger than the depth of the axial recess 32; after one part of the first axial convex member 43 is inserted into the axial recess 32 and fixed therein, the diversion area 5 is formed between the other part of the first axial convex member 43 that is not inserted and the movable member 3, and located at the lower end of the mandrel 4.

For ease of installation, the spool assembly of this embodiment is assembled. Thus, fixation of the stationary member 2 and the mounting base may be designed in several ways. In this embodiment, the lower mounting section 12 of the mounting base 1 comprises an internal wall having a pair of recesses disposed thereon and towards each other, and the stationary member 2 comprises an external wall having a pair of convex parts 22 disposed thereon and towards each other, and the convex parts 22 (shown in FIG. 5) are respectively inserted into corresponding recesses and fixed therein.

Alternatively, the stationary member 2 may be fixed on the mounting base 1 in some other ways. For example, the lower mounting section 12 of the mounting base 1 comprises a female screw arranged thereon and in axial direction, and the stationary member 2 comprises an external wall having a male screw arranged thereon and in axial direction, which matches with female screw. The stationary member 2 is mounted on the lower mounting section 12 through cooperation between the female screw and the male screw.

For better performance of the spool assembly when the mandrel 4 rotates, the mandrel 4 comprises an external wall having two ring-shaped recesses disposed thereon and in axial direction, and each of the two ring-shaped recesses is embedded with a clasp ring 45 (shown in FIG. 3). The embedded snap rings 45 are in clearance fit with the upper mounting section 11 of the mounting base 1.

The mandrel 4 is adapted for driving the movable member 3 to rotate. In order to avoid the attrition of the movable member 3, the movable member 3 comprises an external wall held around by a drag ring 47 (shown in FIG. 3), which is attached to the internal wall of the upper mounting section 11 of the mounting base 1.

For better sealing, the mandrel 4 and the upper mounting section 11 of the mounting base 1 have an O-shaped ring 46 disposed therebetween.

In this embodiment, the shapes of the stationary member diversion area 21 and the movable member diversion area 31 may be diverse, with a precondition that when driven by the mandrel 4, the movable member diversion area 31 may communicate or stagger with the stationary member diversion area 21, along with the change of rotating angle. In this embodiment, the movable member diversion area 31 consists of a pair of sectorial gaps symmetrically arranged along the external wall of the movable member 3, and the stationary member diversion area 21 consists of a pair of sectorial grooves symmetrically disposed on the stationary member 2, shown in FIG. 4 and FIG. 5, so that the mandrel 4 may drive the movable member 3 to rotate in the range 0-90 degree, so as to open or close the spool assembly.

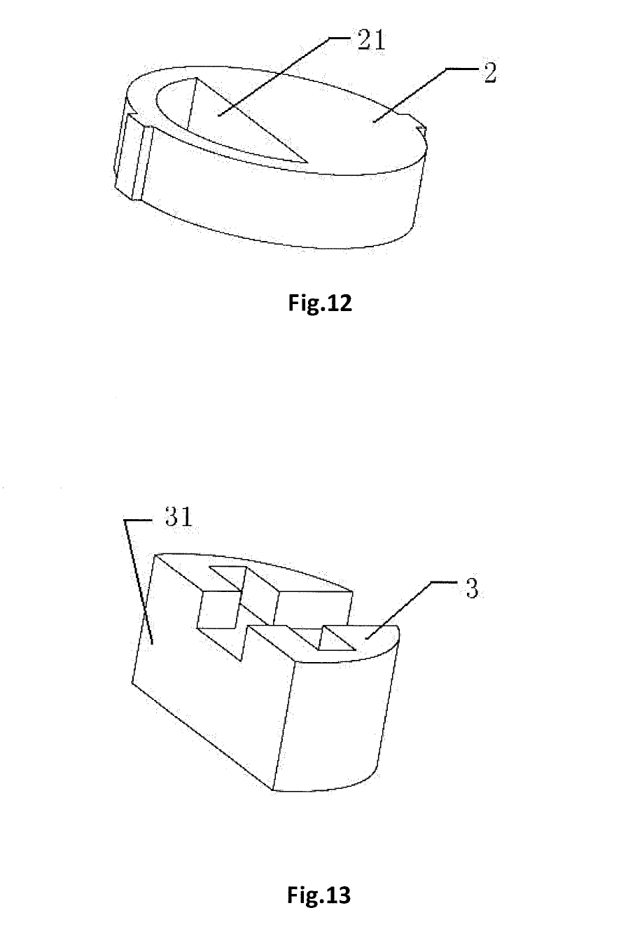

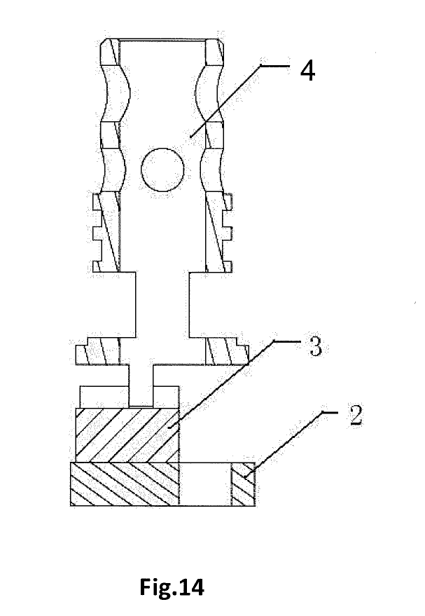

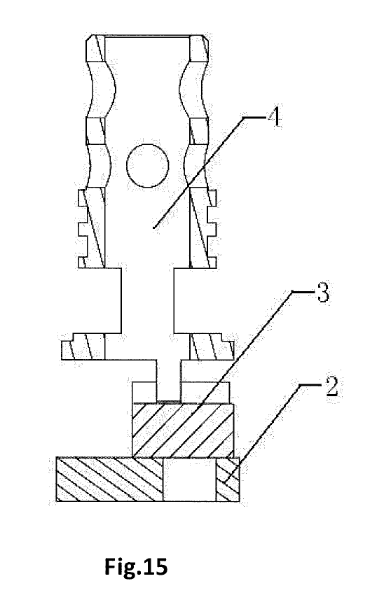

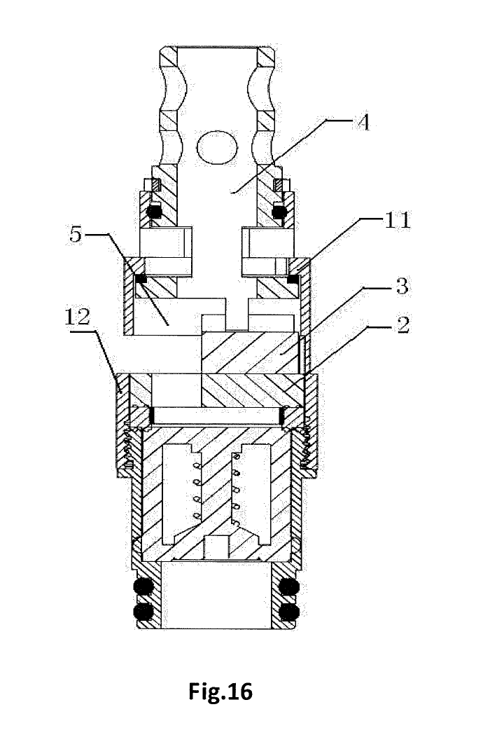

Alternatively, the movable member 3 and the stationary member 2 may be designed in some other ways, one of which are shown in FIG. 12 and FIG. 13 that the stationary member diversion area 21 is a sectorial groove disposed on the stationary member 2, and the movable member diversion area is a sectorial gap arranged along the external wall of the movable member 3. The mandrel 4 drives the movable member 3 to rotate so as to make the movable member diversion area 31 communicate (shown in FIG. 14) or stagger (shown in FIG. 16) with the stationary member diversion area 21. Thus, the spool assembly may be opened or closed when the mandrel 4 drives the movable member 3 to rotate in a range of 0-180 degree.

### Embodiment 2

### Valve Comprising a Spool Assembly of Embodiment 1

Refer to FIG. 11, the valve of this embodiment comprises a tubular valve body 6 having an inlet 7 and an outlet 8; a valve stem 9, disposed inside the valve body 6, one end of which is secured to the mandrel 4 of the spool assembly in a demountable manner, and the other end of which is secured to a rotating controller 10 close to the outlet 8 in a demountable manner; and the spool assembly is disposed close to and coaxial with the inlet 7.

For draining liquid inside the valve body 6, a pneumatic water discharging device 14 is mounted on a side wall of the valve body 6, which is adapted for discharging remaining liquid out of the valve body 6 through the outlet 8 when the valve is closed. It is preferred that the pneumatic water discharging device 14 is disposed towards the outlet 8.

For preventing liquid from flowing back, the valve further comprises a check valve 15, disposed at the inlet 7 and adapted for closing up automatically when pressure on the check valve 15 from inside of the valve body 6 is larger than that from the inlet side.

In this embodiment, the rotating controller 10 is a handwheel that is secured to the valve stem 9 through a first bolt 16. The valve stem 9 is inserted into the valve body 6 through a joint 17 having a convex part projecting inwardly. The valve stem 9 comprises a recess disposed on the external wall, where a connection between the valve stem 9 and the joint 17 is formed, and a snap ring 18 is disposed in the recess and further holds around the valve stem 9. The valve stem 9 further comprises a sleeve 19 disposed at one end thereof, which holds around the external wall of the mandrel 4. The snap ring 18 is clamped by a wall of the recess and a wall of the convex part. A radial screw hole is disposed at the joint between the sleeve 19 and the mandrel, through which a second bolt 20 is disposed to secure the sleeve 19 to the mandrel 4, so as to secure the valve stem 9 to the spool assembly, shown in FIG. 11.

In order to prevent liquid from flowing back when the outlet 8 is connected to a soft tube at a higher position, the valve further comprises a V-shaped ring holding around one end of the valve stem 9 secured to the mandrel 4 of the spool assembly in a demountable manner. The V-shaped ring is firmly attached to an internal wall of the valve body 6 when liquid pressure at the outlet 8 is larger than that at the inlet 7, so that flowing back liquid together with the impurities contained therein are blocked at the V-shaped ring rather than flowing back to the inlet 7.

The assembling of the valve of example 2 is described as follows:

A: the assembling of the spool assembly comprises steps of:

mounting the check valve 15 on the lower mounting section 12 of the mounting base 1;
fixing the stationary member 2 inside the lower mounting section 12 of the mounting base 1, which is located above the check valve 15; and
securing the movable member 3 to the mandrel 4; then,
mounting the mandrel 4 on the upper mounting section 11 of the mounting base 1, and attaching one end face of the movable member 3 to one end face of the stationary member 2, so as to allow the spool assembly to be at its closing state;
after that, the assembling of the spool assembly is completed.

B. securing the valve stem 9 to the spool assembly through the second bolt 20;

C. inserting the valve stem 9 secured to the spool assembly into the valve body 6 through the end that is opposite to the inlet 7 till the inlet 7;

D. securing the valve stem 9 mounted inside the valve body 6 to the handwheel through the first bolt 16;

E. connecting the valve with water resource, and then installation of the valve is completed.

Initially, the valve is at its closing state; the working process of the valve of the embodiment comprises steps of:

rotating the handwheel to drive the valve stem 9 and the mandrel 4 to rotate radially, so as to drive the movable member 3 to rotate, in order to form a superposition area between the movable member diversion area 31 and the stationary member diversion area 21, and the movable member diversion area 31 communicates with the stationary member diversion area 21 (shown in FIG. 8);
when the valve is opened, the superposition area between the movable member diversion area 31 and the stationary member diversion area 21 is gradually increasing along with the increasing rotating angle of the handwheel; during this process, water flows towards the stationary member diversion area 21 and the movable member diversion area 31 through the inlet 7, and one part of water flows towards the outlet 8 of the valve from the first outlet 13, while the other part flows sequentially through the stationary member diversion area 21, the movable member diversion area 31 and the diversion area 5 into the cavity 41 of the mandrel 4, and eventually flows towards the outlet 8 of the valve through the second outlet 42 of the mandrel 4.

To close the valve, it is needed to rotate the handwheel in a reverse direction, so as to decrease the superposition area between the movable member diversion area 31 and the stationary diversion area 21 till completely closing-up. At this stage, the movable member diversion area 31 completely staggers with the stationary member diversion area 21 and the valve is closed.

During the above mentioned process, the superposition area between the movable member diversion area 31 and the stationary member diversion area 21 is changed along with the change of the rotating angle of the handwheel, so as to adjust the amount of water discharge.

Although the present invention has been described with particular reference to certain preferred embodiments thereof, variations and modifications of the present invention can be effected within the spirit and scope of the claims.

1. A spool assembly comprising
an mounting base, having a upper mounting section and a lower mounting section arranged in axial direction;
a first outlet, disposed between said upper mounting section and said lower mounting section,
a mandrel, having a rotating shaft and mounted on said upper mounting section;
a movable member, mounted at a lower end of said mandrel and having a movable member diversion area located on the same plane with said first outlet;
a stationary member, mounted on said lower mounting section, one end face of which may be attached to one end face of said movable member, and having a stationary member diversion area communicated or staggered with said mobile diversion area when said mandrel drives said movable member to rotate;
wherein, said plane may be perpendicular to said rotating shaft, said mandrel has a blocked upper end and a cavity, and at least a second outlet may be disposed on an external wall of said mandrel; the lower end of said mandrel and said movable member have a diversion area located therebetween, which may be in communication with said cavity.

2. The spool assembly of claim 1, wherein, at least one first axial convex member may be disposed at the lower end of said mandrel, and an axial recess may be disposed at an upper end of said movable member; the height of said first convex member may be larger than the depth of said axial recess; after one part of said first axial convex member is inserted into said recess and fixed therein, said diversion area is formed between the other part of said first axial convex member and said movable member and at the lower end of said mandrel.

3. The spool assembly of claim 1, wherein, a first axial convex member and a second axial convex member may be disposed at the lower end of said mandrel, and the height of said first axial convex member may be larger than that of said second axial convex member, and a recess may be disposed on an upper end face of said movable member; after said first axial convex member is inserted into said recess and fixed therein, said diversion area is formed between said second axial convex member and said movable member and at said lower end of said mandrel.

4. The spool assembly of claim 1, wherein, said lower mounting section of said mounting base comprises an internal wall having a pair of recesses disposed thereon and towards each other, and said stationary member comprises an external wall having a pair of convex parts disposed thereon and towards each other, and said convex parts may be respectively inserted into corresponding said recesses.

5. The spool assembly of claim 1, wherein, said movable member diversion area may consist of a pair of sectorial gaps symmetrically arranged along said external wall of said movable member and towards each other, and said stationary member diversion area may consist of a pair of sectorial grooves symmetrically disposed on said stationary member.

6. The spool assembly according to claim 1, wherein, said movable member diversion area may be a sectorial gap arranged along the external wall of said movable member, and said stationary member diversion area may be a sectorial groove disposed on said stationary member.

7. A valve, wherein, comprising a spool assembly of claim 1.

8. The valve of claim 7, wherein, further comprising
a tubular valve body having an inlet and an outlet; and
a valve stem disposed inside said valve body, one end of which may be secured to a mandrel of said spool assembly in a demountable manner, and the other end of which may be secured to a rotating controller close to said outlet in a demountable manner;
wherein, said spool assembly is disposed close to and coaxial with said inlet.

9. The valve of claim 7, wherein, said valve body has a pneumatic water discharging device mounted on a side wall thereof, which is adapted for preventing liquid in said valve body from flowing out of said pneumatic water discharging device when said valve is opened, and for discharging remaining liquid out of said valve body through said outlet when said valve is closed.

10. The valve of claim 7, wherein, further comprising a check valve, disposed at said inlet and adapted for closing up automatically when pressure on said check valve from inside of said valve body is larger than that from inlet side.

11. The valve of claim 8, wherein, further comprising a V-shaped ring holding around one end of said valve stem connected with said mandrel, which is also firmly attached to an internal wall of said valve body when liquid pressure at said outlet is larger than that at said inlet.

12. The spool assembly of claim 2, wherein, said lower mounting section of said mounting base comprises an internal wall having a pair of recesses disposed thereon and towards each other, and said stationary member comprises an external wall having a pair of convex parts disposed thereon and towards each other, and said convex parts may be respectively inserted into corresponding said recesses.

13. The spool assembly of claim 3, wherein, said lower mounting section of said mounting base comprises an internal wall having a pair of recesses disposed thereon and towards each other, and said stationary member comprises an external wall having a pair of convex parts disposed thereon and towards each other, and said convex parts may be respectively inserted into corresponding said recesses.

14. The spool assembly of claim 2, wherein, said movable member diversion area may consist of a pair of sectorial gaps symmetrically arranged along said external wall of said movable member and towards each other, and said stationary member diversion area may consist of a pair of sectorial grooves symmetrically disposed on said stationary member.

15. The spool assembly of claim 3, wherein, said movable member diversion area may consist of a pair of sectorial gaps symmetrically arranged along said external wall of said movable member and towards each other, and said stationary member diversion area may consist of a pair of sectorial grooves symmetrically disposed on said stationary member.

16. The spool assembly of claim 4, wherein, said movable member diversion area may consist of a pair of sectorial gaps symmetrically arranged along said external wall of said movable member and towards each other, and said stationary member diversion area may consist of a pair of sectorial grooves symmetrically disposed on said stationary member.

17. The spool assembly according to claim 2, wherein, said movable member diversion area may be a sectorial gap arranged along the external wall of said movable member, and said stationary member diversion area may be a sectorial groove disposed on said stationary member.

18. The spool assembly according to claim 3, wherein, said movable member diversion area may be a sectorial gap arranged along the external wall of said movable member, and said stationary member diversion area may be a sectorial groove disposed on said stationary member.

19. The spool assembly according to claim 4, wherein, said movable member diversion area may be a sectorial gap arranged along the external wall of said movable member, and said stationary member diversion area may be a sectorial groove disposed on said stationary member.

20. The valve of claim 8, wherein, said valve body has a pneumatic water discharging device mounted on a side wall thereof, which is adapted for preventing liquid in said valve body from flowing out of said pneumatic water discharging device when said valve is opened, and for discharging remaining liquid out of said valve body through said outlet when said valve is closed.
